(19) United States
(12) Patent Application Publication
(10) Pub. No.: US 2026/0299293 A1
(43) Pub. Date: Oct. 1, 2026

(54) DISPLAY DEVICE WITH AN IMAGE-FORMING UNIT WITH A FOLDING MIRROR

(71) Applicant: Continental Automotive Technologies GmbH, Hannover (DE)

(72) Inventor: Daniel KRÜGER, Eichenbühl (DE)

(21) Appl. No.: 19/489,127

(22) PCT Filed: May 7, 2024
(86) PCT No.: PCT/DE2024/200037

§ 371 Date: Dec. 1, 2025

(30) Foreign Application Priority Data
Jun. 5, 2023 (DE) 10 2023 205 229.6

(51) Int. Cl. G02B 27/01; G02B 5/30

(52) U.S. Cl. CPC G02B 27/0101; G02B 5/3025; G02B 5/3083

(57) ABSTRACT

A display device and to transport having a display device of this type. The display device has an image-forming unit for generating an image and an optical unit for projecting the image using a mirror unit. The image-forming unit has a folding mirror, which is arranged between a light source and a display element transilluminated by the light from the light source. The folding mirror has microstructures having first mirror surfaces, which are arranged at a first angle relative to a direction of propagation of the light and are spaced apart from one another to form gaps. Second surfaces are arranged in the gaps, at a second angle relative to the direction of propagation of the light. The width of the gaps varies over a surface of the folding mirror.

### CROSS REFERENCE TO RELATED APPLICATIONS

This is a U.S. national stage of Application No. PCT/DE2024/200037 filed May 7, 2024. Priority is claimed on German Patent Application No. DE 10 2023 205 229.6 filed Jun. 5, 2023, the contents of which are incorporated herein by reference.

### BACKGROUND OF THE INVENTION

### 1. Field of the Invention

The present disclosure relates to a display device comprising an image-forming unit with a folding mirror. The disclosure also relates to a transport comprising a display device of this type.

### 2. Description of the Related Art

A head-up display, also referred to as an HUD, is understood to mean a display system in which the viewer can maintain their viewing direction, since the contents to be represented are superposed into their field of view. While such systems were originally primarily used in the aerospace sector due to their complexity and cost, they are now also being used in large-scale production in the automotive sector.

Head-up displays generally consist of an image-forming unit or PGU (Picture Generating Unit), an optical unit, and a mirror unit. The image-forming unit generates the image and uses at least one display element for this purpose. Most head-up displays today use LCD-based displays (LCD: liquid crystal display) for image generation. The optical unit directs the image onto the mirror unit. The mirror unit is a partially reflective, light-transmissive pane. The viewer thus sees the contents represented by the image-forming unit as a virtual image and at the same time sees the real world behind the pane. In the automotive sector, the windshield is often used as the mirror unit, and the curved shape of the windshield must be taken into account in the representation. Due to the interaction of the optical unit and the mirror unit, the virtual image is an enlarged representation of the image generated by the image-forming unit.

DE 10 2021 214 549 B3 describes a head-up display for a transport, having an image-forming unit for generating an image and an optical unit for projecting the image through a mirror unit. The image-forming unit has a folding mirror that is arranged between a light source and a display element through which it is illuminated at an angle of inclination with respect to the direction of propagation of the light falling on it from the light source. The folding mirror has microstructures, wherein the microstructures have first mirror surfaces which are arranged at a first angle that differs from the angle of inclination of the folding mirror, and are spaced apart from one another so as to form gaps, wherein second surfaces are arranged at a second angle in the gaps.

US 2019/0 212 560 A1 describes a head-up display for a transport, having an image-forming unit for generating an image and an optical system performing a predetermined correction to the image generated by the image-forming unit. The image-forming unit has a light guide with an inclined reflective surface. The reflective surface has a structure with a plurality of reflective partial surfaces.

Depending on the size of the virtual image, head-up displays suffer a greater or lesser loss of homogeneity due to different angles of incidence of the light, in particular on a transparent cover of the optical unit and the windshield. Particularly in the case of what are known as augmented reality head-up displays, i.e. head-up displays for displaying content in the form of augmented reality, with correspondingly large angle spectra on the cover and on the windshield, this can lead to conflicts with customer requirements. Despite the ideally illuminated image-forming device, it is sometimes no longer possible to meet customer requirements with regard to homogeneity solely due to the inhomogeneity caused by the projection system.

The inhomogeneities caused by the projection system run primarily vertically on account of the corresponding geometries. An anti-reflective coating on both sides of the cover can reduce the effect, but not reduce it sufficiently. Moreover, such a coating is costly and therefore not common.

This makes it necessary to compensate for the inhomogeneity by contrasting inhomogeneous illumination of the image-forming device in order to achieve an acceptable homogeneity of the virtual image. For this purpose, for example, the light-emitting diodes (LED; Light Emitting Diode) of a two-dimensional LED matrix illumination responsible for the respective display regions can be subject to different currents. However, high-resolution LED matrix illumination severely restricts design freedom, as it requires more installation space. In addition, more costly LED drivers and more powerful LEDs are required.

Similar problems also occur with other projection systems that use further optical elements with a negative influence on the homogeneity of the projected image.

### SUMMARY OF THE INVENTION

It is an object of one aspect of the present invention to provide alternative solutions for the configuration of a display device which achieve good homogeneity of the projected image.

According to a first aspect of the invention, a display device has an image-forming unit for generating an image and an optical unit for projecting the image by a mirror unit. The image-forming unit here has a folding mirror that is arranged between a light source and a display element that is transilluminated by the light of the light source, wherein the light impinging on the folding mirror is collimated. The folding mirror has microstructures which have first mirror surfaces that always have the same orientation and extent, which are arranged at a first angle relative to a direction of propagation of the light and are spaced apart from one another so as to form gaps. In the gaps, second surfaces are arranged at a second angle relative to the direction of propagation of the light. A width of the gaps here varies over a surface of the folding mirror.

In the solution according to one aspect of the invention, the variation in the width of the gaps over the surface of the folding mirror, i.e. a variation in the distance between adjacent first mirror surfaces, achieves a local change in intensity on the display element. The first mirror surfaces form blades of the folding mirror. According to one aspect of the invention, the reflective blades responsible for a region of the display element that appears too dark are positioned locally at a smaller distance from one another, as a result of which these regions are brightened in the projected image. In this way, all regions of the projected image can be brought to a uniform luminance.

According to one aspect of the invention, the light incident on the folding mirror is collimated. In the solution described, the angle of the first mirror surfaces is constant with respect to the direction of propagation of the light. This is particularly advantageous for collimated input light, since the collimation of the incident light bundle is maintained.

According to one aspect of the invention, the variation of the width of the gaps over the surface of the folding mirror is designed to compensate for an inhomogeneity of the projected image caused by components in a projection path of the display device. By varying the distance between the first mirror surfaces, those parts of the display element that have a worse efficiency in the projection path can be illuminated more strongly along the corresponding axis than those parts of the display element that experience a better efficiency in the projection path. For this purpose, the efficiency of the projection path can be simulated for different image points, which results in a limiting homogeneity. Based on these inhomogeneity data, a polynomial function can be fitted, from which it is ultimately possible to calculate the local width of the gaps in the microstructures which is required to optimize the system homogeneity.

According to one aspect of the invention, the folding mirror is part of a transparent body with a substantially wedge-shaped cross section, in which the wedge base surface is the light input surface facing the light source, the microstructures are arranged on one of the large side surfaces, and the other large side surface is the light output surface facing the display element. In this way, the folding mirror can be realized as a constituent part of a large-volume component that is less susceptible than very thin components. This simplifies the handling during production.

According to one aspect of the invention, a polarizer directs light of a first polarization to the display element and light of a second polarization into the gaps, and a retarder converts the polarization of the light guided into the gaps into the first polarization. The light that is guided into the gaps is guided in the direction of the display element after passing the gaps. This has the advantage that polarization recycling is achieved and light also passes from the gaps to the display element. Usually, only one of the polarization directions generated by the light source is used if a display element that modulates linearly polarized light is used. This is the case, for example, with liquid crystal displays (LCD; Liquid Crystal Display). The normally unused polarization is now converted by the polarizer and retarder into the polarization required by the display element and supplied to it, for which purpose the gaps in the folding mirror are utilized. The light guided into and through the gaps has the same polarization as the light polarized by the first mirror surfaces. The display element is thus illuminated without gaps with light of a single polarization. However, since the recycled light generally has a lower intensity than the light reflected at the first mirror surfaces, further scatterers are preferably provided in the system for sufficient homogenization. In this way, differences in intensity can be avoided.

According to one aspect of the invention, the polarizer is designed as a reflecting polarizer and is formed by the first mirror surfaces. The retarder is designed as a retarder that rotates the polarization direction by 90° and is formed by the gaps. Such a retarder is also referred to as a λ/2 plate or half-wave plate. This embodiment has the advantage that the functions of reflecting light at the mirror surfaces and filling the gaps between the mirror surfaces with light are combined in a single component. Such a component can be prefabricated and tested separately. Moreover, the installation process is made easier.

According to one aspect of the invention, the polarizer is designed as a reflecting polarizer and is disposed between the folding mirror and the display element. The retarder is designed as a retarder that converts linear into circular polarization, and is arranged between the folding mirror and the polarizer. In this embodiment, the retarder is a retarder that converts linear into circular polarization and is traversed twice by the light. Such a retarder is also referred to as a λ/4 plate or quarter-wave plate. In this case, the effect of a λ/2 plate is thus split and the delay is distributed over two passes. The retarder of this embodiment is arranged between the folding mirror and the polarizer. This has the advantage that the components can have a flat configuration, whereby cost-effective components from mass production can be used.

According to one aspect of the invention, the reflecting polarizer is inclined at an angle differing from 90° to the direction of propagation of the light that is incident on it coming from the folding mirror. The second surfaces in this case are designed as mirror surfaces and are arranged parallel to the reflecting polarizer. This has the advantage that light reflected by the reflecting polarizer that is not or scarcely divergent is not reflected back to the first mirror surfaces but, if angles and distances are suitably chosen, is reflected back to one of the second mirror surfaces in the gaps. It is reflected by these parallel to the light reflected by the first mirror surfaces in the direction of the polarizer, from which it is transmitted by the retarder after adjustment of the polarization direction. Thus, a very large part of the light of both polarizations is used, and almost no dark regions are caused by the gaps.

A display device according to the invention is preferably used in a transport. The transport can be, for example, a motor vehicle, but alternatively also an aircraft, a rail vehicle or a watercraft. In particular, the display device can be configured here as a head-up display. However, it goes without saying that a display device can also be used in other fields of application and designed as another type of projection system.

Further features of the present invention will become apparent from the following description and the appended claims in connection with the figures.

### BRIEF DESCRIPTION OF THE DRAWINGS

FIG. 1 is a head-up display according to the prior art for a motor vehicle;

FIG. 2 is the image-forming unit of a head-up display;

FIG. 3 is an image-forming unit of a display device;

FIG. 4 is a folding mirror of the image-forming unit from FIG. 3;

FIG. 5 is an image-forming unit with polarization recycling;

FIG. 6 is an image-forming unit with polarization recycling;

FIG. 7 is an image-forming unit with polarization recycling; and

FIG. 8 is a transport.

### DETAILED DESCRIPTION OF THE PRESENTLY PREFERRED EMBODIMENTS

For better understanding of the principles of the present invention, embodiments of the invention are explained in more detail below with reference to the figures. The same reference numerals are used in the figures for identical or functionally identical elements and are not necessarily described again for each figure. It is to be understood that the invention is not restricted to the illustrated embodiments and that the features described may also be combined or modified without departing from the scope of protection of the invention as defined in the appended claims.

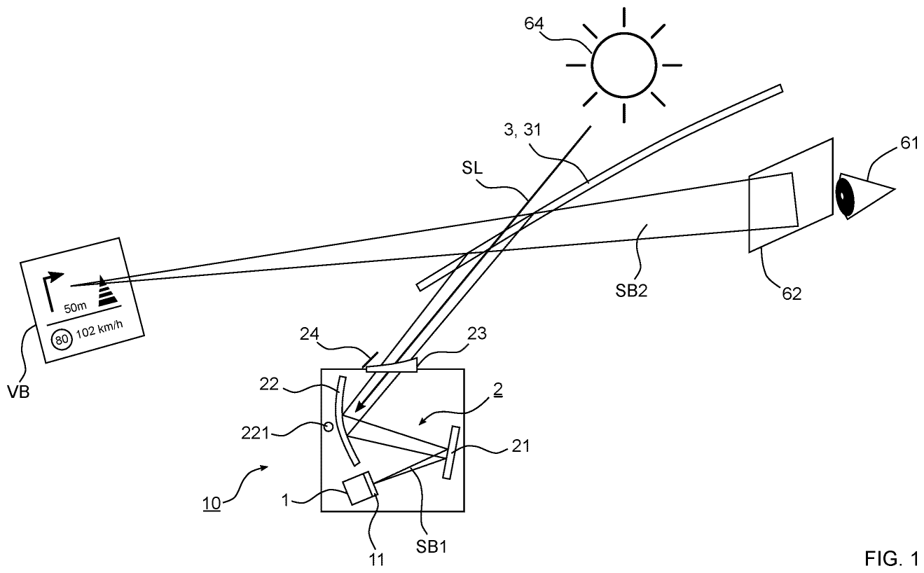

FIG. 1 shows a schematic diagram of a head-up display for a motor vehicle according to the prior art as an example of a display device 10. The head-up display has an image-forming unit 1, an optical unit 2, and a mirror unit 3. A beam bundle SB1 emanates from a display element 11 and is reflected by a first mirror 21 onto a curved mirror 22 that reflects it in the direction of the mirror unit 3. The mirror unit 3 is illustrated here as a windshield 31 of the motor vehicle. From there, the beam bundle SB2 travels in the direction of an eye 61 of a viewer.

The viewer sees a virtual image VB that is located outside the motor vehicle above the engine hood or even in front of the motor vehicle. Due to the interaction of the optical unit 2 and the mirror unit 3, the virtual image VB is an enlarged representation of the image displayed by the display element 11. A speed limit, the current vehicle speed, and navigation instructions are symbolically represented here. As long as the eye 61 is located within the eyebox 62 indicated by a rectangle, all elements of the virtual image are visible to that eye 61. If the eye 61 is outside the eyebox 62, the virtual image VB is only partially visible to the viewer, or not at all. The larger the eyebox 62 is, the less restricted the viewer is when choosing their seating position. The curvature of the curved mirror 22 is adapted to the curvature of the windshield 31 and ensures that the image distortion is stable over the entire eyebox 62. The curved mirror 22 is rotatably mounted by a bearing 221. The rotation of the curved mirror 22 that is made possible thereby makes it possible to displace the eyebox 62 and thus to adapt the position of the eyebox 62 to the position of the eye 61. The first mirror 21 serves to ensure that the path traveled by the beam bundle SB1 between the display element 11 and the curved mirror 22 is long and, at the same time, that the optical unit 2 is nevertheless compact. The optical unit 2 is delimited with respect to the environment by a transparent cover 23. The optical elements of the optical unit 2 are thus protected for example against dust located in the interior of the motor vehicle. An anti-glare protection 24 serves to reliably absorb the light reflected via the interface of the cover 23 so that the observer is not dazzled. In addition to the sunlight SL, the light from another stray light source 63 can also reach the display element 11.

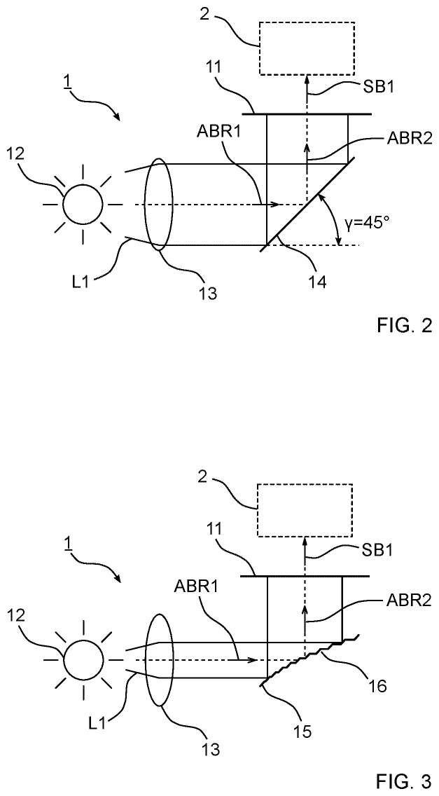

FIG. 2 schematically shows the image-forming unit 1 of a head-up display. The light source 12 is visible, the light from which is collimated by a collimator 13. The collimated light bundle is reflected by a mirror 14 which, in the example illustrated, is arranged at an angle of γ=45° to the direction of propagation ABR1 of the light L1, and illuminates, in its direction of propagation ABR2, which is oriented at an angle of 90° to the direction of propagation ABR1, the display element 11, from where it enters, as the beam bundle SB1, the optical unit 2 which is only schematically shown here. The display element 11 is not necessarily arranged at right angles to the direction of propagation ABR2, but rather can also be arranged at an angle differing from 90°.

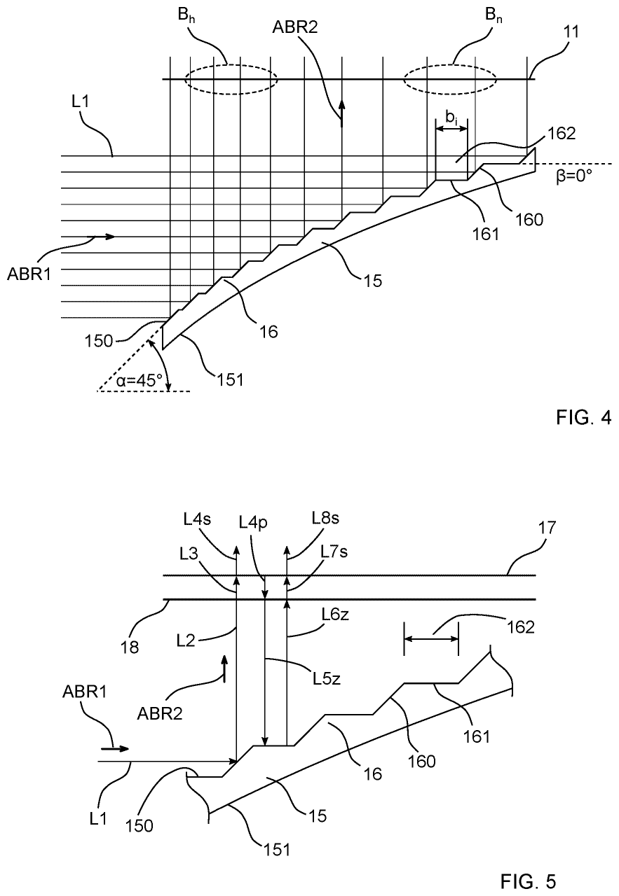

FIG. 3 schematically shows the image-forming unit 1 of a display device 10 according to the invention. It shows the folding mirror 15 according to the invention, which is arranged in the optical path between the light source 12 and the display element 11 that is transilluminated by the light L1 of the light source 12. FIG. 4 schematically shows an enlarged view of the folding mirror 15. The upper boundary surface 150 of the folding mirror 15 has microstructures 16. By contrast, the lower boundary surface 151 does not have any particular essential optical or geometric properties. The microstructures 16 have first mirror surfaces 160, which are arranged at a first angle α relative to a direction of propagation ABR1 of the light L1 and are spaced apart from one another so as to form the gaps 162. Second surfaces 161 are arranged in the gaps 162, at a second angle β relative to the direction of propagation ABR1 of the light L1. In the example shown, the first angle is α=45°, whereas the second angle is 0°. A width bᵢ of the gaps 162 varies here over a surface of the folding mirror 15. The reflecting flanks, i.e. the first mirror surfaces 160, always have the same orientation and extent. This has the effect that the surface area of the folding mirror 15 is not formed by a plane base surface. For those image regions Bₕ of the display element 11 for which a higher luminance is desired, the folding mirror 15 has gaps 162 with a small width bᵢ. For those image regions Bₙ of the display element 11 for which a lower luminance is desired, the folding mirror 15 instead has gaps 162 with a larger width bᵢ. The size of the microstructures 16 shown is exaggerated in order to improve the understanding of the principle of the solution according to the invention. In FIG. 4, the width bᵢ of the gaps 162 increases from left to right, for example. However, it is not stipulated that the regions Bₙ are always on the right and the regions Bₕ are always on the left of the image generator. This depends, in particular, on the number of mirrors in the projection optical unit. In the inverse case, the gaps 162 between the first mirror surfaces 160 would become smaller, not larger going from left to right. The folding mirror 15 would thus be curved in the opposite direction.

FIG. 5 schematically shows a first aspect of the invention with polarization recycling. It shows, again, the folding mirror 15 with its microstructures 16. In this example, the first mirror surfaces 160 of the microstructures 16 have an angle of 45° relative to the direction of propagation ABR1 of the incident light. Depending on installation space specifications, angles deviating from 45° can also be realized. The second surfaces 161 arranged in the gaps 162 between the first mirror surfaces 160 are likewise designed as reflective surfaces. The second surfaces 161 are oriented in this example parallel to the direction of propagation ABR1 of the incident light, but this is not necessarily the case. A retarder 18 and a polarizer 17 are arranged above the folding mirror 15. In the example illustrated, these are separated by air, but can alternatively also be installed in laminated fashion. In the present exemplary embodiment, the retarder 18 has the property of a quarter-wave plate, so that it converts linearly polarized input light into circularly polarized output light, and vice versa. The polarizer 17 is a reflecting polarizer that allows linearly polarized light with a first polarization direction to pass through and reflects polarized light perpendicularly thereto. The display element is located at a distance above the polarizer 17 and is not shown here.

From the left, collimated unpolarized light L1 falls in the direction of propagation ABR1 onto the folding mirror 15. As already explained above, however, variants with no incident collimated light can also be realized. For the sake of clarity, only one light beam is shown here by way of example. This unpolarized light L1 is reflected by the first mirror surfaces 160. In the direction of propagation ABR2, it reaches the retarder 18 as unpolarized light L2, passes through it and leaves it as unpolarized light L3. It impinges on the reflecting polarizer 17, which, in the example shown, allows s-polarized light L4s to pass through (transmits) and throws back (reflects) p-polarized light L4p. For the sake of clarity, this is schematically illustrated in the figure as offset to the right. The p-polarized light L4p passes through the retarder 18 and leaves it as circularly polarized light L5z. This is incident on the reflectively second surfaces 161 and reflected from these as circularly polarized light L6z back to the retarder 18. It passes through this and leaves it as s-polarized light L7s. This light passes through the reflecting polarizer 17 since it now has the polarization direction which the polarizer does not reflect but rather transmit. Thus, additional s-polarized light L8s travels to the display element. It is to be understood that the polarization orientations are interchangeable, i.e., the reflecting polarizer 17 can alternatively also transmit p-polarized light and reflect s-polarized light. In this case, p-polarized light travels in the direction of the display element.

In the illustration, the respectively described light is drawn parallel to the respective direction of propagation ABR1, ABR2 and is shown laterally offset after a reflection on the polarizer 17 or on a reflectively second surface 161. The latter indicates that, despite the collimation, the light normally does not consist of ideally parallel rays, but of at least slightly divergent rays. As soon as an extended real light source is used, the collimated beam always has a certain angular spectrum. In practice, a light diffuser for sufficient homogenization can also be provided between the collimator and the folding mirror 15, as a result of which the angular spectrum is further enlarged. The slightly divergent rays are to a large extent reflected obliquely by the polarizer 17, so that they reach one of the reflectively second surfaces 161 and are reflected again there. In addition or as an alternative, the first mirror surfaces 160 can be provided with a slight curvature which already makes the light L2 reflected by them more divergent than the light L1 impinging on them. Further possibilities include corrugating or tilting the polarizer 17. In the case of an inclination, the inclination of the reflective second surfaces 161 is advantageously adapted in order to minimize the angular deviation. With one or more of these measures, some of the light L4s transmitted by the polarizer 17 already fills some of the dark regions in the light, caused by the gaps 162, that run toward the display element. On the other hand, light L8s also reaches these dark regions. Consequently, more of the originally incident light L1 reaches the display element.

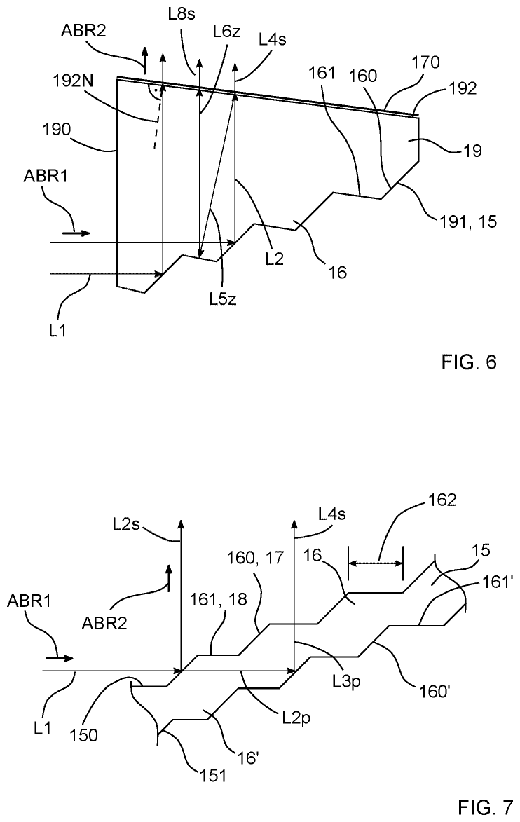

FIG. 6 schematically shows a second apect of the invention with polarization recycling. In this embodiment, the folding mirror 15 is designed as a transparent body 19. The transparent body 19 has a substantially wedge-shaped cross section. The tip of the wedge, which is on the right in the figure, is capped and therefore not shown. The wedge base surface 190 is the light input surface facing the light source. The microstructures 16 are arranged on one of the large side surfaces 191 of the wedge. The other large side surface 192 of the wedge forms the light output surface facing the display element.

In FIG. 6, the first mirror surfaces 160 are, as described above, arranged at an angle of 45° to the directions of propagation ABR1, ABR2. The reflective second surfaces 161 are however not arranged parallel to the direction of propagation ABR1, but are tilted thereto at an acute angle. They are inclined such that they do not stand in the way of the light L1 entering from the left on its way to one of the first mirror surfaces 160, but rather are inclined away from one first mirror surface 160 to the next as seen in its direction of propagation. The other large side surface 192 of the wedge-shaped transparent body 19 has the same inclination as the reflective second surfaces 161. This is indicated by the acute angle between the normal 192N of the side surface 192 and the direction of propagation ABR2. The polarizer, embodied here as a reflective circular polarizer 170, which also intrinsically combines the function of the retarder, is arranged on the side surface 192, and thus has the same inclination. The first large side surface 191 is provided with a mirror coating.

From the left, collimated unpolarized light L1 falls in the direction of propagation ABR1 onto the folding mirror 15. For the sake of clarity, only a few light rays are shown here by way of example. This unpolarized light L1 is reflected by the first mirror surfaces 160. It reaches the reflective circular polarizer 170 as unpolarized light L2 in the direction of propagation ABR2. This transmits s-polarized light L4s and reflects circularly polarized light L5z. Due to the slight tilt of the perpendicular on the side surface 192 with respect to the direction of propagation ABR2, this circularly polarized light L5z propagates at an angle differing from 0°to the direction of propagation ABR2. This light falls on the reflective second surfaces 161 and is reflected from these as circularly polarized light L6z back to the retarder. Due to the inclined arrangement of the reflective second surfaces 161, this light now propagates again parallel to the direction of propagation ABR2. It falls on the reflective circular polarizer 170 and is transmitted by it. Consequently, further s-polarized light L8s travels towards the display element.

FIG. 6 is an example of the variant of an aspect of the invention in which the reflecting polarizer 170 is inclined at an angle differing from 90° with respect to the direction of propagation ABR2 of the light L2 that is incident on it and comes from the folding mirror 15, and in which the reflective second surfaces 161 are arranged parallel to the reflecting polarizer 170. The embodiment of the folding mirror 15 as a transparent body 19 can, of course, also be used independently of polarization recycling.

FIG. 7 schematically shows a third aspect of the invention with polarization recycling. Here, the folding mirror 15 has an upper boundary surface 150 and a lower boundary surface 151, both of which are arranged parallel to one another and have microstructures 16, 16′ arranged offset with respect to one another. In the exemplary embodiment shown, the offset is chosen such that first mirror surfaces 160 of the upper boundary surface 150 and first mirror surfaces 160′ of the lower boundary surface 151 follow one another in the direction of propagation ABR1 of the light L1 coming from the light source. In the direction of propagation ABR2 perpendicular thereto, first mirror surfaces 160 of the upper boundary surface 150 and second surfaces 161′ of the lower boundary surface 151 follow one another, and second surfaces 161 of the upper boundary surface 150 and first mirror surfaces 160′ of the lower boundary surface 151 follow one another. The first mirror surfaces 160 of the upper boundary surface 150 are configured as a reflective polarizer 17. The second surfaces 161 of the upper boundary surface 150 are designed as retarders 18 rotating the polarization direction by 90°. The first mirror surfaces 160′ of the lower boundary surface 151 are embodied as mirrors that do not influence the polarization. The first mirror surfaces 160, 160′ are arranged at an angle of 45° both to the direction of propagation ABR1 of the light L1 coming from the light source and to the direction of propagation ABR2 of the light traveling to the display element. The second surfaces 161, 161′ are arranged parallel to the direction of propagation ABR1 of the light L1 coming from the light source.

From the left, collimated unpolarized light L1 falls in the direction of propagation ABR1 onto the folding mirror 15. For the sake of clarity, only one light ray is shown here by way of example. This unpolarized light L1 is reflected by the first mirror surfaces 160, in this example as s-polarized light L2s, and is transmitted as p-polarized light L2p. The s-polarized light L2s travels in the direction of propagation ABR2 in the direction of the display element. The p-polarized light L2p is reflected by the first mirror surfaces 160′ of the lower boundary surface 151 and reaches the second surfaces 161 of the upper boundary surface 150 from the inside as p-polarized light L3p. Since these are designed as retarders 18 that rotate the polarization by 90°, they transmit the light impinging on them, which leaves them as s-polarized light L4s in the direction of propagation ABR2 in the region of the gaps 162. Consequently, further s-polarized light L4s travels towards the display element. It goes without saying that the polarization orientations are interchangeable in this embodiment as well.

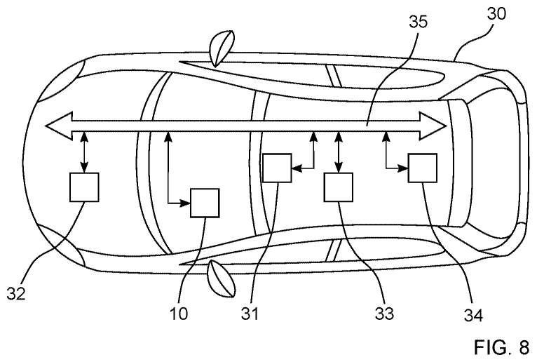

FIG. 8 schematically shows a transport 100, in which a solution according to aspects of the invention is implemented. The transport 100 is in this example a motor vehicle. A sensor system 101 can be used to capture data pertaining to the vehicle surroundings. The sensor system 101 may in particular comprise surroundings recognition sensors, for example ultrasound sensors, laser scanners, radar sensors, lidar sensors or cameras. The information captured by the sensor system 101 can be used to generate contents to be displayed for the display device 10. Further components of the motor vehicle in this example are a navigation system 102, by which positional information can be provided, and also a data transmission unit 103. By means of the data transmission unit 103, for example a connection to a back-end can be set up, for example to obtain updated software for components of the motor vehicle. A memory 104 is available for storing data. Data is exchanged between the various components of the motor vehicle via a network 105.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-9. (canceled)

10. A display device, comprising:
an image-forming unit configured to generate an image, comprising:
a folding mirror arranged between a light source and a display element that is transilluminated by a light of the light source, wherein the light that is incident on the folding mirror is collimated,
wherein the folding mirror has microstructures having:
first mirror surfaces that always have a same orientation and extent, which are arranged at a first angle relative to a direction of propagation of the light and are spaced apart from one another so as to form gaps; and
second surfaces at a second angle relative to the direction of propagation of the light and are arranged in the gaps,
wherein a width of the gaps varies over a surface of the folding mirror; and
an optical unit configured to project the image by a mirror unit.

11. The display device according to claim 10, wherein the variation in the width of the gaps over the surface of the folding mirror compensates for an inhomogeneity of a projected image caused by one or more of the mirror unit, a cover of the optical unit, and a windshield of a transport in a projection path of the display device.

12. The display device according to claim 10, wherein the folding mirror is part of a transparent body with an essentially wedge-shaped cross section, in which a wedge base surface is a light input surface facing the light source, the microstructures are arranged on one of a respective large side surfaces, and an other respective large side surface is a light output surface facing the display element.

13. The display device according to claim 10, further comprising:
a polarizer configured to guide light of a first polarization to the display element and light of a second polarization into the gaps; and
a retarder configured to convert polarization of the light (L2p, L4p) guided into the gaps into the first polarization;
wherein the light guided into the gaps is guided in the direction of the display element after passing through the gaps.

14. The display device according to claim 13, wherein:
the polarizer is a reflecting polarizer and is formed by the first mirror surfaces; and
the retarder rotates by 90° a polarization direction and is formed by the gaps.

15. The display device according to claim 13, wherein:
the polarizer is a reflecting polarizer and is arranged between the folding mirror and the display element, and
the retarder converts linear into circular polarization and is arranged between the folding mirror and the polarizer.

16. The display device according to claim 15, wherein the reflecting polarizer is inclined at an angle differing from 90° relative to the direction of propagation of incident light coming upon it from the folding mirror, and the second surfaces are designed as mirror surfaces and are arranged parallel to the reflecting polarizer.

17. A transport comprising:
a display device, comprising:
an image-forming unit configured to generate an image, comprising:
a folding mirror arranged between a light source and a display element that is transilluminated by a light of the light source, wherein the light that is incident on the folding mirror is collimated,
wherein the folding mirror has microstructures having:
first mirror surfaces that always have a same orientation and extent, which are arranged at a first angle relative to a direction of propagation of the light and are spaced apart from one another so as to form gaps; and
second surfaces at a second angle relative to the direction of propagation of the light and are arranged in the gaps,
wherein a width of the gaps varies over a surface of the folding mirror; and
an optical unit configured to project the image by a mirror unit.

18. The transport according to claim 17, wherein the display device is a head-up display.
